(19) United States
(12) Patent Application Publication
(10) Pub. No.: US 2014/0353262 A1
(43) Pub. Date: Dec. 4, 2014

(54) SELF-CLEANING FUEL PUMP

(71) Applicant: John E. Troxler, Logansport, IN (US)

(72) Inventor: John E. Troxler, Logansport, IN (US)

(73) Assignee: CARTER FUEL SYSTEMS, LLC, Logansport, IN (US)

(21) Appl. No.: 14/293,759

(22) Filed: Jun. 2, 2014

Related U.S. Application Data
(60) Provisional application No. 61/829,897, filed on May 31, 2013.

(51) Int. Cl. B01D 29/66; B01D 35/00

(52) U.S. Cl. CPC B01D 29/66; B01D 35/005
USPC 210/791; 210/136; 210/411

(57) ABSTRACT

A method and system for removing contaminants from a filter member positioned on the inlet of a fuel pump with an electric DC motor. The polarity of the motor control circuit is reversed causing the DC motor to run in reverse discharging residual fuel in the fuel pump through the filter member.

### CROSS REFERENCE TO RELATED APPLICATION

This application claims the priority benefit of U.S. Provisional Patent Application Ser. No. 61/829,897, titled “Self-Cleaning Fuel Pump,” and filed on May 31, 2013, which is expressly incorporated by reference herein in its entirety.

### TECHNICAL FIELD

The present disclosure relates to fuel supply and delivery systems for internal combustion engines, and more particularly to cleaning methods for the fuel pumps in said systems.

### BACKGROUND

Electric fuel pumps are currently used in fuel supply and delivery systems for internal combustion systems. Fuel pumps are typically positioned in the main fuel tanks or reserve fuel tanks and are used to supply fuel to the engine.

Unfortunately, a significant amount of contaminate can collect inside a fuel tank. The contaminate can be introduced to the fuel tank during the dispensing of fuel into the tank. Also, steel tanks tend to oxidize over time and the oxidation debris can collect at the bottom of the fuel tank. The contaminants can also increase the wear and reduce the life of the fuel pumps.

In most gasoline fuel systems today, filters, such as mesh-type filters, are used to filter out contaminants and prevent them from entering the fuel pump and creating problems. However, the filters themselves often get clogged with debris and other contaminants necessitating a complete fuel pump replacement.

It is an object of the present invention to provide an improved system for preventing the clogging of fuel pumps with contaminants. It is another object of the present invention to provide an improved method for cleaning and unclogging fuel pump filters members.

### SUMMARY

The present invention provides a unique system and method for cleaning and refreshing fuel pump filters to prevent them from being clogged with contaminants. The filters are preferably mesh-type filters and are positioned at the intake ports to the fuel pumps. The fuel pumps are electric fuel pumps and contain DC motors, preferably brushless DC motors.

In order to dislodge contaminants and other debris from the filters, the fuel flow is reversed in the fuel pump. The motor controller circuit reverses the voltage polarity periodically, such as when the power to the pump is turned off. This reverses the fuel low through the filter.

A check valve at the outlet port of the fuel pump is normally closed when the fuel pump motor is off and reversed. The fuel remaining in the fuel pump is discharged out through the inlet and through the filter, thereby cleaning and purging the filter of debris other contaminants.

Other features and benefits of the invention will become apparent from the following description of embodiment of the invention when viewed in accordance with the attached drawings and appended claims.

### BRIEF DESCRIPTION OF THE DRAWINGS

These and other features and advantages of the present invention will become more readily appreciated when considered in connection with the following detailed description and appending drawings, wherein:

FIG. 1 is a schematic drawing of a fuel pump control circuit in accordance with an embodiment of the invention.

FIG. 2 schematically depicts normal fuel flow in an electric fuel pump system.

FIG. 3 schematically illustrates use of a preferred embodiment of the present invention with a typical electric fuel pump system.

### DESCRIPTION OF THE PREFERRED EMBODIMENTS

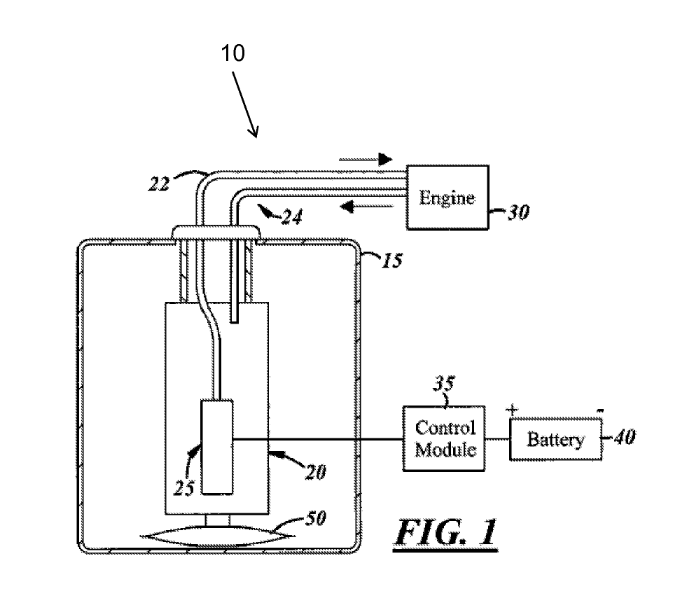

FIG. 1 schematically depicts a fuel supply and delivery system along with a controller system for controlling the operation of the fuel pump. The entire system is referred to generally by the reference numeral 10.

The representative fuel pump supply and delivery system 10 includes a main fuel tank 15, a fuel pump 20, and an engine 30. A filter 50 is positioned on the intake to the fuel pump 20. The control system includes a control module 35 and a battery 40.

In the operation of the fuel supply and delivery system 10, fuel is passed from the main fuel tank 15 to the engine 30.

The fuel pump 20 can be any of the conventional fuel pumps known today, such as, for example, turbine, gerotor, or rollervane fuel pumps. All fuel pumps are sensitive to contamination. Turbine fuel pumps are used on multi-port fuel injected engines for several U.S. vehicle manufacturers today.

The fuel pump 20 can be positioned inside a fuel tank or reservoir tank in a hanger-type structure (not shown) or fuel module reservoir. The hanger-type structure is mounted under the cover of the fuel tank 15, or reservoir tank, and the bottom of the hanger and the fuel pump 20 is typically positioned at or adjacent to the bottom of the tank.

The filter 50 is positioned at the inlet to the fuel pump 20 and generally filters out contaminants, such as particles or other debris, from entering the fuel pump. The principal contaminants are particles of metal or rust, or debris in the fuel supply. Contaminants in the fuel pump 20 can cause undue wear of the internal fuel pump components, such as the impeller, and can clog or block the flow of fuel through the fuel pump 20. This can reduce the output and efficiency of the fuel pump, as well as and the entire fuel supply and delivery system.

The filter 50 for the fuel pump 20 can be made of a synthetic mesh-type material, such as nylon or polyester mesh. The filter can have a single layer of material, or have multiple layers.

The fuel pump 20 supplies fuel from the fuel tank 15 to the engine 30. Typically, the fuel pump 20 supplies the fuel through a fuel delivery line 22 to a fuel line internal to the engine that feeds the fuel injectors. Excess fuel in the fuel line is returned to the reservoir tank through fuel return line 24.

The fuel pump 20 can include a DC motor 25. The motor 25 can be a brush-type DC electric motor, but preferably is a brushless DC motor. Since the motor 25 is a DC motor, it can be powered by the battery 40 and electronic control module or unit 35. The electronic control module can be mounted on the fuel pump assembly, external to the fuel pump assembly, or mounted on the vehicle.

When the filter 50 becomes clogged with contaminants and other debris, the methods and systems described herein can unclog or otherwise clean the filter 50. In accordance with the present invention, the debris positioned on, or attached to, the filter 50 is forced away by reversing the fuel flow back out of the fuel pump intake and through the filter 50. When the pump 20 is turned off, a control circuit operated by the control module 35 provides a reverse voltage polarity along with sufficient stored reverse power to reverse the DC polarity field within the fuel pump's magnetic circuit. This causes the flow to be reversed through the fuel pump 20 and out the inlet port. The fuel flow also proceeds through the filter 50. This forces the contaminants off the filter and cleans it.

The motor control circuit could be programmed to reverse the polarity and reverse the flow through the fuel pump automatically every time that the engine is turned off. Alternatively, the motor controller circuit could be programmed to supply the reverse polarity momentarily during start-up of the vehicle or both during start-up and shut down of the fuel pump.

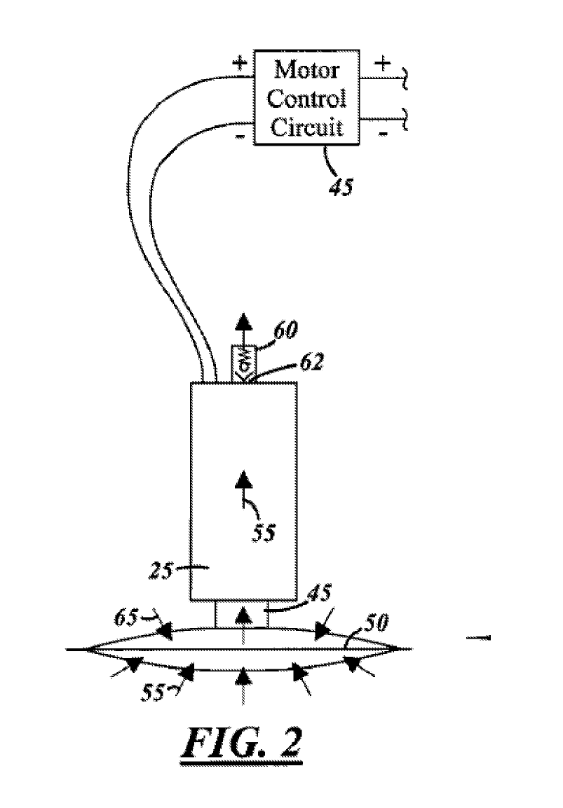

FIG. 2 depicts a motor 25 and motor control circuit 45 during normal operation when the pump is turned on and is in normal operation. The polarity of the motor control is shown by the “+” and “−” designations. This is the normal polarity when the fuel pump 20 is running and supplying fuel for operations of the engine 30.

The direction of the fuel through the filter 50 and the fuel pump 20 is shown by the arrows 55. The filter is positioned at the pump inlet 45. FIG. 2 also shows a check valve 60 on the outlet port 62 of the motor 25. The check valve 60 is open when the fuel pump is operating normally.

As indicated above, the motor 25 in the fuel pump 20 can be either a brush-type or brushless DC motor, and preferably is a brushless DC motor.

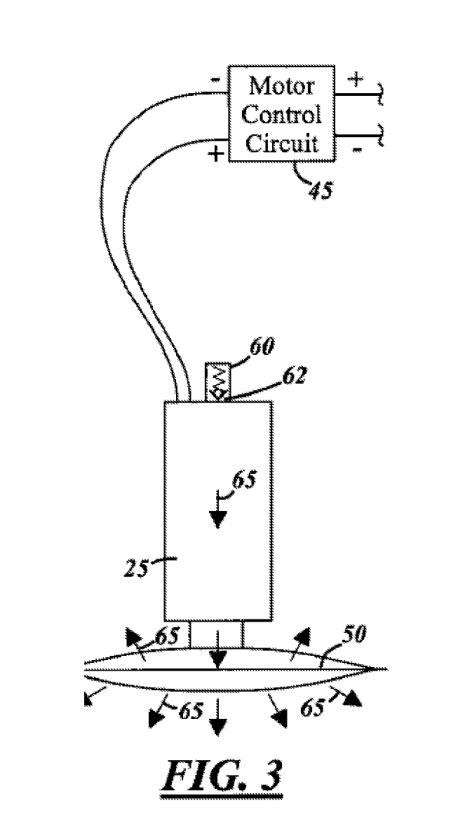

FIG. 3 depicts the same motor 25 and filter member 50 when the polarity of the member control circuit 45 is momentarily reversed. In accordance with preferred embodiments of the invention, this reversal is programmed to take place either when the pump is shut off or when the pump is started up.

The reversed polarity causes the DC motor 25 to turn in reverse direction purging internal residual fuel back out of the pump 20 through the inlet and through the filter member 50. The reversal of the fuel is indicated by the arrows 65. When the direction of the flow in the pump is reversed, the check valve in the pump outlet post 62 is closed. The check valve 60 is normally closed when the pump is off.

Any contaminants adhering to the surfaces or mesh weaves of filter 50 will be expelled away from the surfaces creating a self-clean action.

Although the invention has been described with respect to preferred embodiments, it is to be also understood that it is not to be so limited since changes and modifications can be made therein which are within the full scope of this invention as detailed by the following claims.

What is claimed is:

1. A method of removing contaminants from a filler member positioned on the intake of a fuel pump, said method comprising the steps of:
positioning a fuel pump in a fuel tank, said fuel pump having an intake port and outlet port and being an electric DC operated fuel pump;
providing an electric DC control circuit for operating the fuel pump;
providing a filter member adjacent the intake port on the fuel pump; and reversing the polarity of the electric DC control circuit;
wherein the reversal of polarity causes the DC motor in the fuel pump to turn in reverse forcing residual fuel in the fuel pump out through said inlet port and out through the filter member.

2. The method of removing contaminants from a filter member as described in claim 1 wherein said reversal of polarity of the electric DC control areas is momentary and periodic.

3. The method of removing contaminants from a filter member as described in claim 1 wherein said reversal of polarity of the electric DC control area occurs during shut down of said fuel pump.

4. The method of removing contaminants from a filter member as described in claim 1 wherein said reversal of polarity of the electric DC control area occurs during start up of said fuel pump.

5. The method of removing contaminants from a filter member as described in claim 1 wherein said DC motor is a brushless DC motor or brush DC motor.

6. The method of removing contaminants from a filter member as described in claim 1 wherein said filter member is a mesh filter member.

7. The method of removing contaminants from a filter member as described in claim 1 further comprising a check valve in said outlet port, and further comprising the step of closing said check valve during reversal of the operation of the DC motor.

8. A system for removing contaminants from a fuel pump filter member, said system comprising:
a fuel pump having an electric DC motor, an inlet port and an outlet port;
a motor control circuit for operating said electric DC motor;
a filter member positioned at said inlet port of said fuel pump;
wherein said motor control circuit is programmed to reverse the polarity of said electric DC motor and reverse the flow of the residual fuel in said fuel pump.

9. The system for removing contaminants from a fuel pump filter member as described in claim 8 wherein said reversal of polarity is programmed to take place when the pump is turned off.

10. The system for removing contaminants from a fuel pump filter member as described in claim 8 wherein said reversal of polarity is programmed to take place when the pump is turned on.

11. The system for removing contaminants from a fuel pump filter member as described in claim 8 further comprising a check valve on said outlet port, and wherein said check valve is closed during reversal of said polarity and reversal of the flow of fuel.
